(19) United States
(12) Patent Application Publication
(10) Pub. No.: US 2017/0132003 A1
(43) Pub. Date: May 11, 2017

(54) System and Method for Hardware Multithreading to Improve VLIW DSP Performance and Efficiency

(71) Applicant: Futurewei Technologies, Inc., Plano, TX (US)

(72) Inventors: Tong Sun, Allen, TX (US); Ying Xu, Campbell, CA (US); Weizhong Chen, Austin, TX (US)

(21) Appl. No.: 14/937,093

(22) Filed: Nov. 10, 2015

(51) Int. Cl. G06F 9/30; G06F 9/48

(52) U.S. Cl. CPC G06F 9/3009; G06F 9/3012; G06F 9/4881

(57) ABSTRACT

A system and method of hardware multithreading in VLIW DSPs includes an instruction fetch and dispatch unit, a plurality of program control units coupled to the instruction fetch and dispatch unit, a plurality of function units coupled to the plurality of program control units, and a mode control unit coupled to the function units and the program control units, the mode control unit configured to dynamically organize the plurality of function units and the plurality of program control units into one or more threads, each thread comprising a program control of the plurality of program control units and a subset of the plurality of function units.

### TECHNICAL FIELD

The present invention relates generally to managing the allocation of resources in a computer, and in particular embodiments, to techniques and mechanisms for hardware multithreading to improve very long instruction word (VLIW) digital signal processor (DSP) performance and efficiency.

### BACKGROUND

In DSP design, better performance may be achieved by creating a smaller number of higher-performing DSP cores, as opposed to a greater number of lower-performing DSP cores. A fewer quantity of cores may reduce the interconnection cost when fabricating the DSP. For example, a DSP with fewer cores may achieve reduced silicon area and/or power consumption. Further, a reduction in the interconnect complexity may simplify inter-core communication and reduce synchronization overhead, thereby increasing the power efficiency of a DSP.

DSP performance may also be increased by the use of VLIW instructions, whereby multiple instructions may be issued to a DSP in a single VLIW instruction bundle. Instructions in a VLIW bundle may be executed in parallel. However, this increase in efficiency may be limited by the amount of parallelism in algorithms or software. For example, certain types of wireless baseband signal processing may not “scale out” efficiently at the instruction level. Additionally, some types of single instruction, multiple data (SIMD) operations may not scale out efficiently. Techniques to increase the performance of algorithms that do not scale out well at the instruction level are thus needed.

### SUMMARY OF THE INVENTION

Technical advantages are generally achieved, by embodiments of this disclosure which describe hardware multithreading to improve VLIW DSP performance and efficiency.

In accordance with an embodiment, a processor includes an instruction fetch and dispatch unit, a plurality of program control units coupled to the instruction fetch and dispatch unit, a plurality of function units coupled to the plurality of program control units, and a mode control unit coupled to the function units and the program control units, the mode control unit configured to dynamically organize the plurality of function units and the plurality of program control units into one or more threads, each thread comprising a program control of the plurality of program control units and a subset of the plurality of function units.

In accordance with another embodiment, a method for organizing a processor includes selecting, by a mode control unit, a quantity of threads into which to divide a processor, dividing, by the mode control unit, function units into function unit groups, the quantity of function unit groups being equal to the quantity of threads, and allocating, by the mode control unit, a register file into a plurality of thread register files, each of the thread register files being allocated to one of the function unit groups.

In accordance with yet another embodiment, a device includes a processor comprising function units and a register file, and a computer-readable storage medium storing a program to be executed by the processor, the program including instructions for selecting a quantity of threads into which to divide the processor, dividing the function units into function unit groups, the quantity of function unit groups being equal to the quantity of threads, and allocating the register file into a plurality of thread register files, each of the thread register files being allocated to one of the function unit groups.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 illustrates a block diagram of an embodiment processing system;

FIG. 2 illustrates an embodiment single-threaded VLIW DSP;

FIG. 3 illustrates an embodiment symmetrically partitioned multithreaded VLIW DSP;

FIG. 4 illustrates an embodiment asymmetrically partitioned multithreaded VLIW DSP;

FIG. 5 illustrates an embodiment multithreaded VLIW DSP with shared function units;

FIG. 6 illustrates an embodiment multiplexer;

FIG. 7 illustrates an embodiment symmetric thread partition;

FIG. 8 illustrates an embodiment asymmetric thread partition;

FIG. 9 illustrates an embodiment shared function unit thread partition; and

FIG. 10 illustrates an embodiment method for configuring a multithreaded VLIW DSP.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of embodiments of this disclosure are discussed in detail below. It should be appreciated, however, that the concepts disclosed herein can be embodied in a wide variety of specific contexts, and that the specific embodiments discussed herein are merely illustrative and do not serve to limit the scope of the claims. Further, it should be understood that various changes, substitutions and alterations can be made herein without departing from the spirit and scope of this disclosure as defined by the appended claims.

Disclosed herein is a multithreading technique to improve VLIW DSP performance and efficiency. In an M-way VLIW processor, up to M instructions may be executed in each clock cycle. In other words, each VLIW instruction word may include M instructions. Embodiment VLIW DSPs may adapt to run in single thread mode for applications that have sufficient instruction-level parallelism. For applications that do not contain sufficient instruction-level parallelism, embodiment VLIW DSPs may run in a multithreading mode, which may include dividing an M-way VLIW processor into N smaller processors (or “threads”). Accordingly, each smaller processor may be capable of executing (M÷N) instructions in each clock cycle. For example, an embodiment DSP that supports an 8-instruction VLIW may configure itself into two threads that each support a 4-instruction VLIW. Likewise, a register file in an embodiment VLIW DSP may be divided into N smaller register files, each of which is used by one of the N smaller processors. Applications that do not scale well through instruction-level parallelism may perform better if there are more threads available for the application, even if those threads are less capable than a single large processor. Such applications may be designed with thread-level parallelism (sometimes called “coarse-grained parallelism”), so that they take advantage of the more numerous but less capable threads.

Embodiment VLIW DSPs contain many function units that respond to different instructions, and may adapt to different multithreading configurations through a mode control unit that maps and groups the function units. For example, embodiment VLIW DSPs may be configured as a single large processor with a high degree of parallelism by grouping all function units into a single thread. Alternatively, embodiment VLIW DSPs may be configured to include multiple smaller threads by grouping the function units into several smaller groups. Function units may be exclusively assigned to, or shared between different threads.

Various embodiments may achieve advantages. Because the efficiency of VLIW processors and SIMD parallel processing has been reached, embodiments may offer other ways to increase the performance of DSPs. By implementing multithreaded parallel processing in DSP cores, the execution efficiency of software on DSP cores may be increased. Depending on the application being executed, embodiments may increase the performance of DSP cores by up to 33% with a corresponding increase in silicon area of only about 10%. Increases in the efficient of silicon area may result in cost reductions and increased power efficiency.

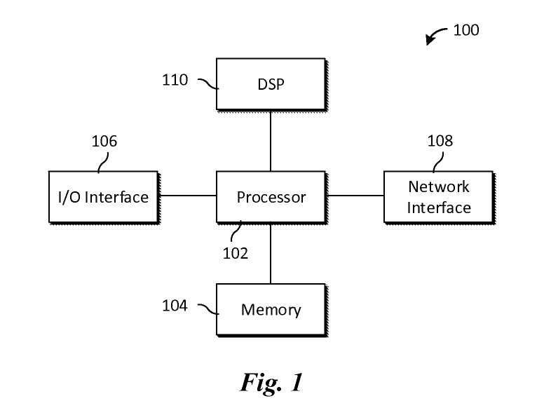

FIG. 1 illustrates a block diagram of an embodiment processing system 100 for performing methods described herein, which may be installed in a host device. As shown, the processing system 100 includes a processor 102, a memory 104, an I/O interface 106, a network interface 108, and a DSP 110, which may (or may not) be arranged as shown in FIG. 1. The processor 102 may be any component or collection of components adapted to perform computations and/or other processing related tasks, and the memory 104 may be any component or collection of components adapted to store programs and/or instructions for execution by the processor 102. In an embodiment, the memory 104 includes a non-transitory computer readable medium. The I/O interface 106 and/or the network interface 108 may be any component or collection of components that allow the processing system 100 to communicate with other devices/components and/or a user. The processing system 100 may include additional components not depicted in FIG. 1, such as long term storage (e.g., non-volatile memory, etc.).

The DSP 110 may be a standalone device in the processing system 100, or may be co-located with another component of the processing system 100. In some embodiments, the processor 102 may be part of the DSP 110, i.e., the DSP 110 has processing capabilities as well as digital signal processing capabilities.

In some embodiments, the processing system 100 is included in a network device that is accessing, or part otherwise of, a telecommunications network. In one example, the processing system 100 is in a network-side device in a wireless or wireline telecommunications network, such as a base station, a relay station, a scheduler, a controller, a gateway, a router, an applications server, or any other device in the telecommunications network. In other embodiments, the processing system 100 is in a user-side device accessing a wireless or wireline telecommunications network, such as a mobile station, a user equipment (UE), a personal computer (PC), a tablet, a wearable communications device (e.g., a smartwatch, etc.), or any other device adapted to access a telecommunications network.

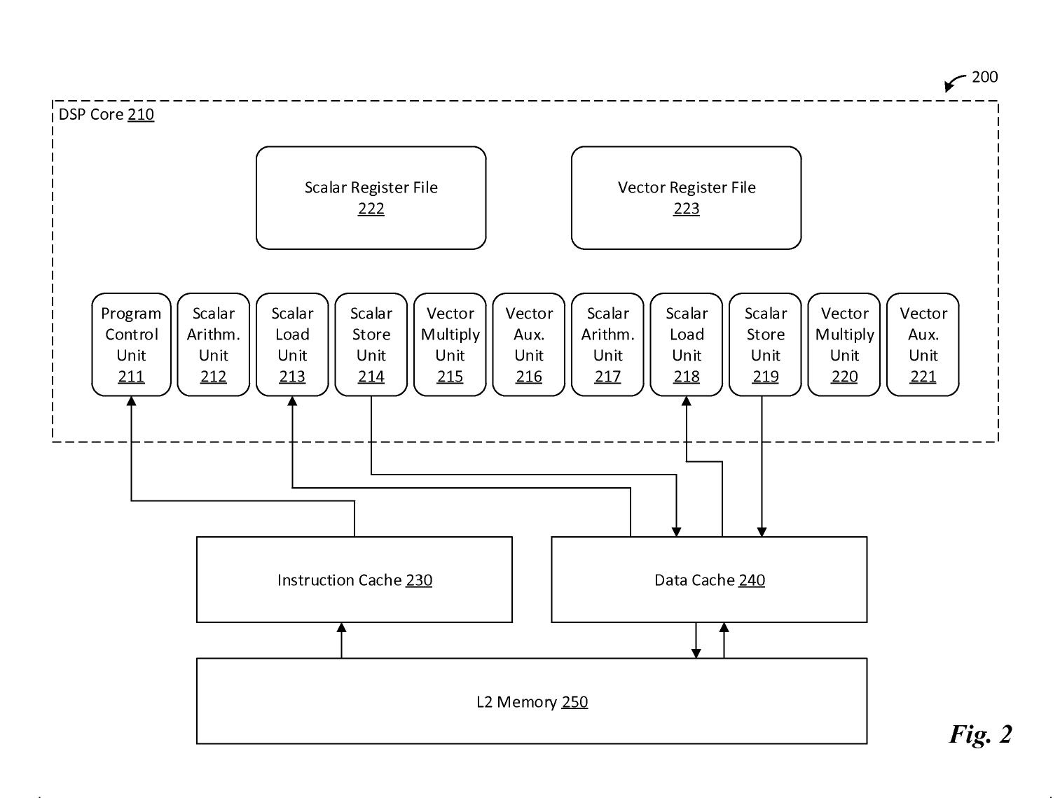

FIG. 2 illustrates an embodiment single-threaded VLIW DSP 200. The single-threaded VLIW DSP 200 includes a DSP core 210, an instruction cache 230, a data cache 240, and level 2 (L2) memory 250. The DSP core 210 includes a program control unit (PCU) 211, scalar arithmetic units 212, 217, scalar load units 213, 218, scalar store units 214, 219, vector multiply units 215, 220, vector auxiliary units 216, 221, a scalar register file 222, and a vector register file 223. As shown in FIG. 2, these function units have all been grouped to create a single DSP core 210. The single-threaded VLIW DSP 200 is thus so-named because it is operating in single-threaded mode.

The DSP core 210 is configured to contain duplicates of some function units. For example, the DSP core 210 includes two of each scalar arithmetic, load, and store units. It also includes two of each vector multiply and auxiliary units. By configuring the DSP core 210 with more function units, it is thus able to execute more instructions in a VLIW, and therefore has a higher degree of instruction-level parallelism. For example, if the single-threaded VLIW DSP 200 can respond to an 8-instruction VLIW, then the DSP core 210 may handle all eight instructions.

The PCU 211 may act as the central control function unit for a thread. The PCU 211 may be configured so a thread operates in wide mode, where it has many function units, or in narrow mode, where it has fewer function units. A single, wide thread may be beneficial for applications that include sufficient instruction-level parallelism. Conversely, multiple, narrow threads may be beneficial for application that lack instruction-level parallelism but have been designed to include sufficient thread-level parallelism. In some embodiments, the PCUs may be switched between wide and narrow mode semi-statically or dynamically. For example, some applications may have some portions that are designed to take advantage of instruction-level parallelism and other portions that are designed to take advantage of thread-level parallelism. The portions designed for instruction-level parallelism may be performed when the VLIW DSP is configured to include a single, wide thread, e.g., the single-threaded VLIW DSP 200, and the portions designed for thread-level parallelism may be performed after the VLIW DSP is reconfigured to include multiple, narrow threads, as will be discussed in greater detail below. If a workload can be balanced across multiple threads, overall processing efficiency may be increased since the function units will be better utilized.

The PCU 211 reads instructions from the instruction cache 230 and executes them on the DSP core 210. The instruction cache 230 may cache instructions from the L2 memory 250. As will be discussed below, there may be multiple PCUs executing instructions from the instruction cache 230. The data cache 240 may buffer reads and writes to/from the L2 memory 250 performed by the function units.

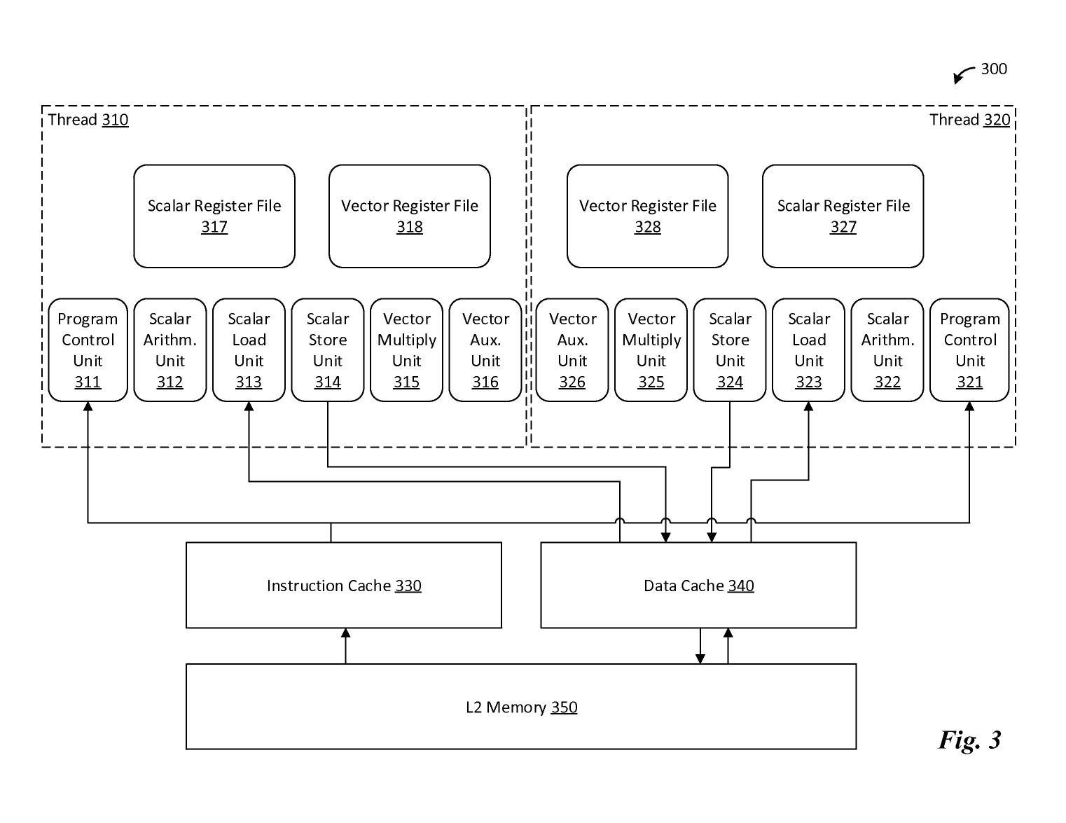

FIG. 3 illustrates an embodiment symmetrically partitioned multithreaded VLIW DSP 300. The symmetrically partitioned multithreaded VLIW DSP 300 includes threads 310, 320, an instruction cache 330, a data cache 340, and L2 memory 350. Each of the threads 310, 320 are independent threads that have been created from a single DSP core, e.g., a single-threaded VLIW DSP that has been reconfigured to include multiple threads.

Each of the threads 310, 320 includes PCUs 311, 321, scalar arithmetic units 312, 322, scalar load units 313, 323, scalar store units 314, 324, vector multiply units 315, 325, vector auxiliary units 316, 326, scalar register files 317, 327, and vector register files 318, 328. Like the single-threaded VLIW DSP 200 in FIG. 2, the various function units are connected to the instruction cache 330 and the data cache 340, which themselves are connected to the L2 memory 350. As shown in FIG. 3, these function units have been grouped to create two of the threads 310, 320, which may have similar capabilities.

The PCUs 311, 321 may each comprise an interrupt controller so that each of the threads 310, 320 are capable of responding to different interrupt requests without disrupting one another. Assignment of the interrupt requests to the PCUs 311, 321 may be controlled by an application executed on the symmetrically partitioned multithreaded VLIW DSP 300.

The instruction cache 330 may be shared by the threads 310, 320. In some embodiments, both of the threads 310, 320 may alternate use of the same read port of the instruction cache 330. In some embodiments, each of the threads 310, 320 may be connected to a dedicated port of the instruction cache 330. In embodiments where the instruction cache 330 is a multiple-banked cache, the instruction cache 330 may be designed to support multiple read ports. The data cache 340, like the instruction cache 330, may also have one or a plurality of ports shared by multiple threads.

In some embodiments, the threads 310, 320 may share the same program code. In such embodiments, each of the threads 310, 320 may have its own copies of global and static variables. Allowing each of the threads 310, 320 to have their own copies of the data may be accomplished through address translation. For example, the values of duplicate global and static variables may be fixed in the data cache 340 and/or the L2 memory 350 and then the different addresses for each thread's copy may be mapped to that thread through memory mapping.

As seen in FIG. 3, the registers and function units of the symmetrically partitioned multithreaded VLIW DSP 300 have been symmetrically split between the threads 310, 320. That is, each thread contains one set of scalar function units, one set of vector function units, one scalar register file, and one vector register file. A single vector register file in a DSP core may be divided between threads in the DSP core. For example, when the original scalar register file includes sixty-four 32-bit registers and the vector register file includes thirty-two 128-bit registers, each of the threads 310, 320 may be assigned thirty-two 32-bit registers and sixteen 128-bit registers. In such an example, each of the threads 310, 320 has equal parallelism capability, which is approximately half of the total parallelism capability of the symmetrically partitioned multithreaded VLIW DSP 300. It should be appreciated that embodiment multithreaded VLIW DSPs need not necessarily be configured symmetrically, and that the function units and register files may be divided and grouped in any number of ways.

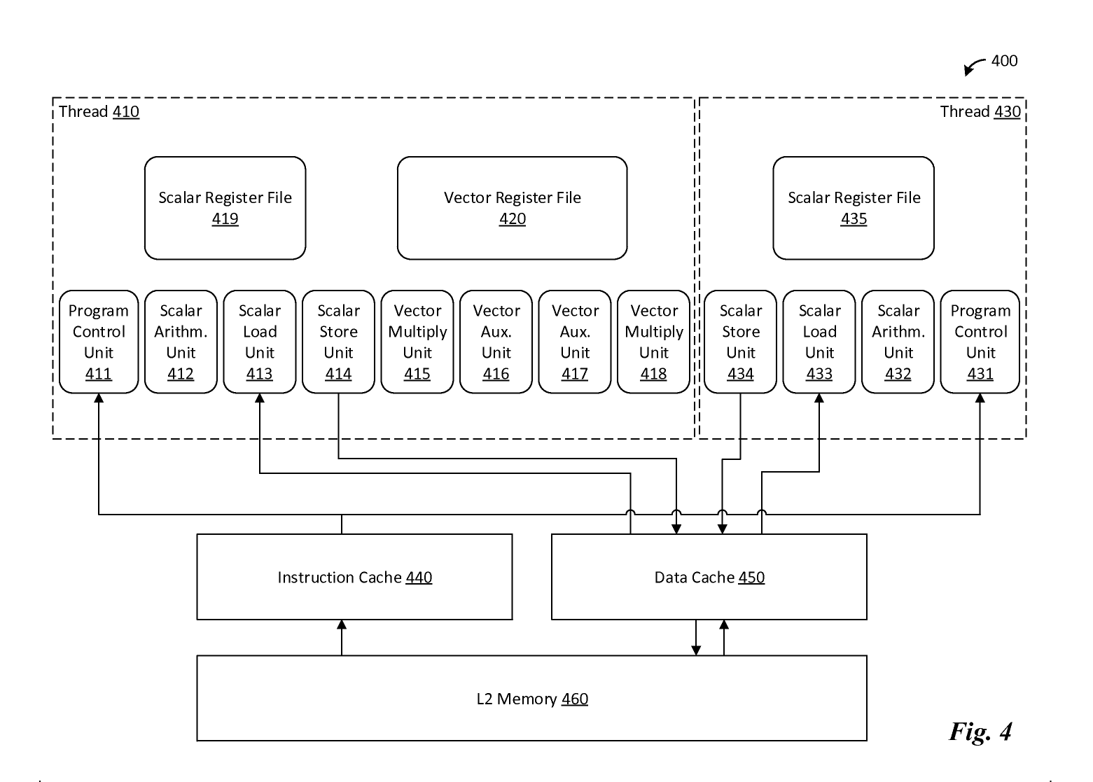

FIG. 4 illustrates an embodiment asymmetrically partitioned multithreaded VLIW DSP 400. The asymmetrically partitioned multithreaded VLIW DSP 400 includes threads 410, 430, an instruction cache 440, a data cache 450, and L2 memory 460. Like the single-threaded VLIW DSP of FIG. 2, the various function units in the threads 410, 430 are connected to the instruction cache 440 and the data cache 450, which themselves are connected to the L2 memory 460. As shown in FIG. 4, various function units have been grouped and included in the threads 410, 430, to form two threads having unequal capabilities.

The threads 410, 430 include PCUs 411, 431, scalar arithmetic units 412, 432, scalar load units 413, 433, scalar store units 414, 434, and scalar register files 419, 435. However, unlike the symmetrically partitioned multithreaded VLIW DSP 300 illustrated in FIG. 3, the asymmetrically partitioned multithreaded VLIW DSP 400 is asymmetrically split. That is, while both threads 410, 430 include scalar function units and register files, the thread 410 further includes vector multiply units 415, 418, vector auxiliary units 416, 417, and a vector register file 420. The thread 410 thus has a higher degree of instruction-level parallelism than the thread 430.

The asymmetrically partitioned multithreaded VLIW DSP 400 may be asymmetrically split to accommodate the needs of various threads in an application that supports thread-level parallelism. For example, when executing an application where one thread demands a higher degree of instruction-level parallelism than another thread, a VLIW DSP may be split asymmetrically, like the asymmetrically partitioned multithreaded VLIW DSP 400 of FIG. 4.

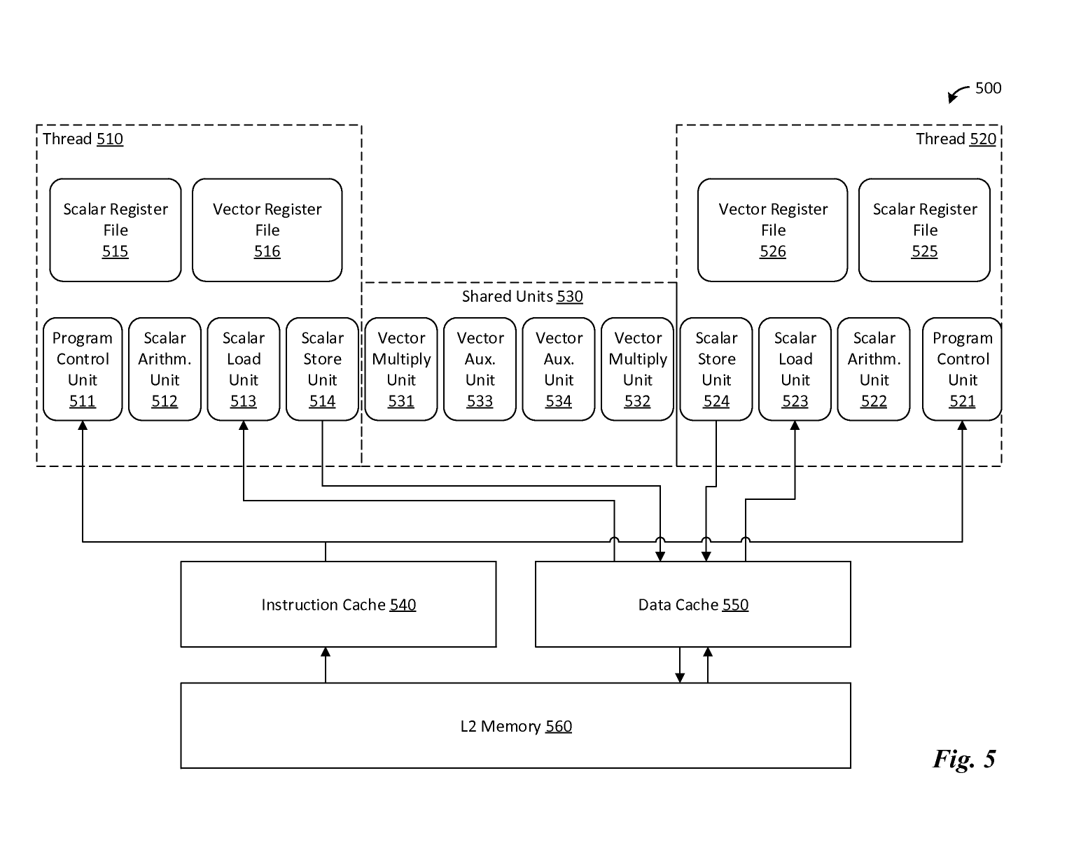

FIG. 5 illustrates an embodiment multithreaded VLIW DSP with shared function units 500. The multithreaded VLIW DSP with shared function units 500 includes threads 510, 520, shared units 530, an instruction cache 540, a data cache 550, and L2 memory 560. Unlike the symmetric or asymmetric multithreaded VLIW DSPs discussed above, the multithreaded VLIW DSP with shared function units 500 does not have all function units exclusively assigned to threads. Rather, the threads 510, 520 comprise PCUs 511, 521, scalar arithmetic units 512, 522, scalar load units 513, 523, scalar store units 514, 524, scalar register files 515, 525, and vector register files 516, 526, respectively. Like the single-threaded VLIW DSP of FIG. 2, the various function units in the threads 510, 520 are connected to the instruction cache 540 and the data cache 550, which themselves are connected to the L2 memory 560.

Unlike some embodiment symmetric or asymmetric multithreaded VLIW DSPs, the threads 510, 520 share the shared units 530. The shared units 530 include vector multiply units 531, 532 and vector auxiliary units 533, 534. These function units may be accessed by one of the threads 510, 520 in a given clock cycle. For example, the threads 510, 520 may equally share access to the shared units 530. As another example, the thread 510 may access the shared units 530 for more or less clock cycles than the thread 520. It should be appreciated that any division of access to the shared units 530 is possible, and the division may depend on the needs of applications running on the multithreaded VLIW DSP with shared function units 500.

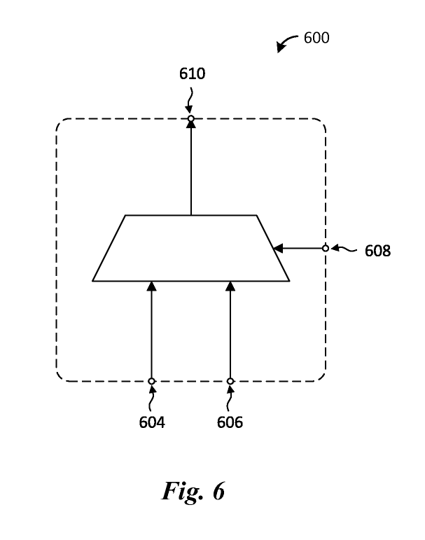

FIG. 6 illustrates an embodiment multiplexer 600. The multiplexer 600 selects a control signal from a PCU and electrically connects that control signal to a VLIW function unit. Selecting a control signal thus selects the PCU that accesses a function unit. The multiplexer 600 includes PCU control inputs 604, 606, a control line 608, and a function unit output 610. The PCU control inputs 604, 606 may each be connected to a PCU. The control line 608 may be connected to a mode control unit, which will be discussed below in more detail. The function unit output 610 is connected to a VLIW function unit.

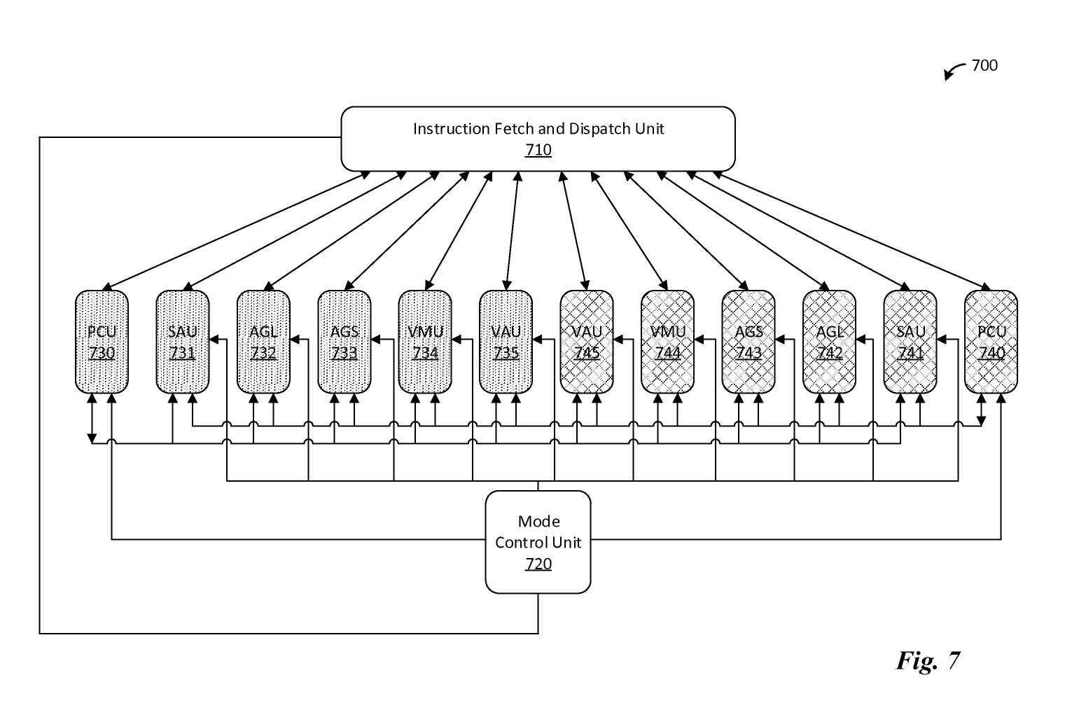

FIG. 7 illustrates an embodiment symmetric thread partition 700. The symmetric thread partition 700 includes an instruction fetch and dispatch unit 710, a mode control unit 720, program control units (PCU) 730, 740, scalar arithmetic units (SAU) 731, 741, scalar load units (AGL) 732, 742, scalar store units (AGS) 733, 743, vector multiply units (VMU) 734, 744, and vector auxiliary units (VAU) 735, 745. The symmetric thread partition 700 may be indicative of partitioned function units in a symmetric multithreaded VLIW DSP.

The instruction fetch and dispatch unit 710 is coupled to the mode control unit 720 and the other function units in the symmetric thread partition 700. The instruction fetch and dispatch unit 710 separates the instructions packed in a VLIW and dispatches them to the different threads. It may have one shared read port, or different read ports for different threads.

The mode control unit 720 organizes function units into threads and allocates function units and registers to different threads. The mode control unit 720 has control lines that are connected to the multiplexers in the different function units, as illustrated above with respect to the control lines 608 of FIG. 6. By changing the values on the control lines for each function unit, the mode control unit 720 is able to change which PCU 730, 740 the function units are connected to and thus associated with. By changing the associated PCU, the function units may thus be moved and allocated between different threads.

The function units illustrated in the symmetric thread partition 700 are organized into two threads: a first thread (indicated by the dotted hash pattern), and a second thread (indicated by the diagonal hash pattern). However, the PCU 730 is connected to all function units in the symmetric thread partition 700, including function units in threads that the PCU 730 does not participate in. That is, the PCU 730 is physically connected to function units in the second thread even though the PCU 730 is participating in the first thread. Likewise, the PCU 740 is also physically connected to all other function units in the symmetric thread partition 700, including those in threads the PCU 740 does not participate in. This function unit interconnection is possible due to the multiplexer in each function unit, discussed above with respect to FIG. 6. Thus, while each function unit may be physically connected to a PCU, it may not be electrically connected unless the electrical pathway to the PCU is enabled by the multiplexer.

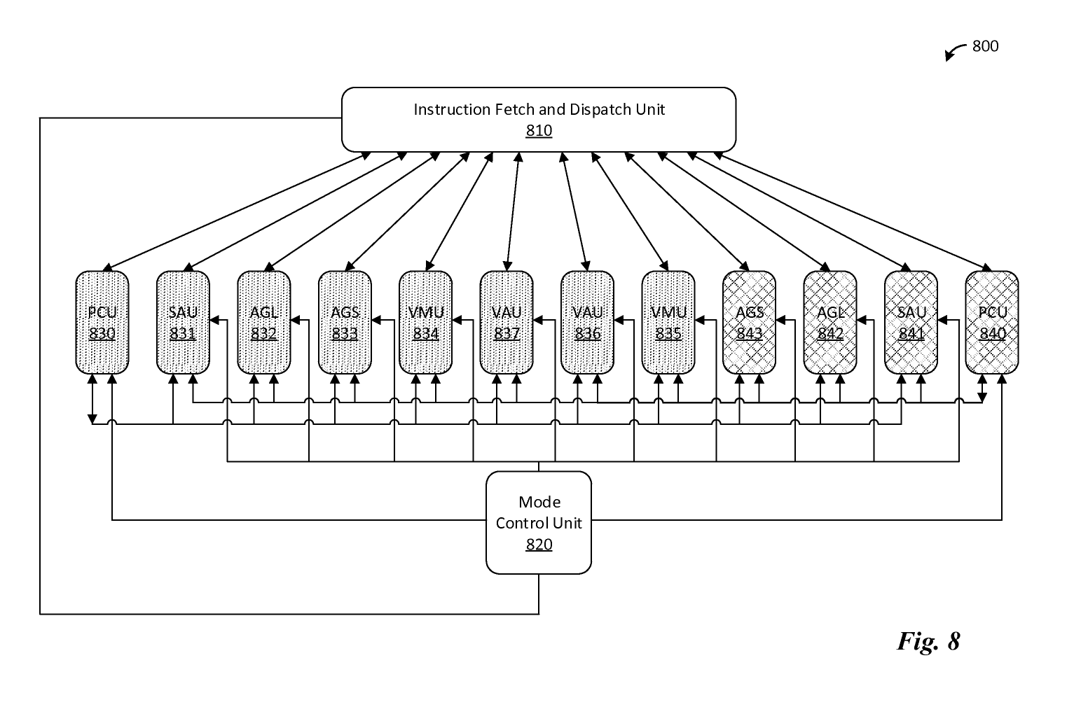

FIG. 8 illustrates an embodiment asymmetric thread partition 800. The asymmetric thread partition 800 includes an instruction fetch and dispatch unit 810, a mode control unit 820, PCUs 830, 840, SAUs 831, 841, AGLs 832, 842, AGSs 833, 843, VMUs 834, 835, and VAUs 836, 837. The asymmetric thread partition 800 may be indicative of partitioned function units in an asymmetric multithreaded VLIW DSP.

As shown in FIG. 8, the PCU 830, SAU 831, AGL 832, AGS 833, VMUs 834, 835, and VAUs 836, 837 have been organized into a first thread (indicated by the dotted hash pattern). Likewise, the PCU 840, SAU 841, AGL 842, and AGS 843 have been organized into a second thread (indicated by the diagonal hash pattern). The first thread may thus have a higher degree of parallelism than the second thread, since it contains more function units. Also, the first thread of the asymmetric thread partition 800 may have a higher degree of parallelism for vector functions than the first thread of the symmetric thread partition 700, since it contains more vector function units. The organization of the function units in the asymmetric thread partition 800 may be performed by the mode control unit 820, as discussed above with respect to FIG. 7.

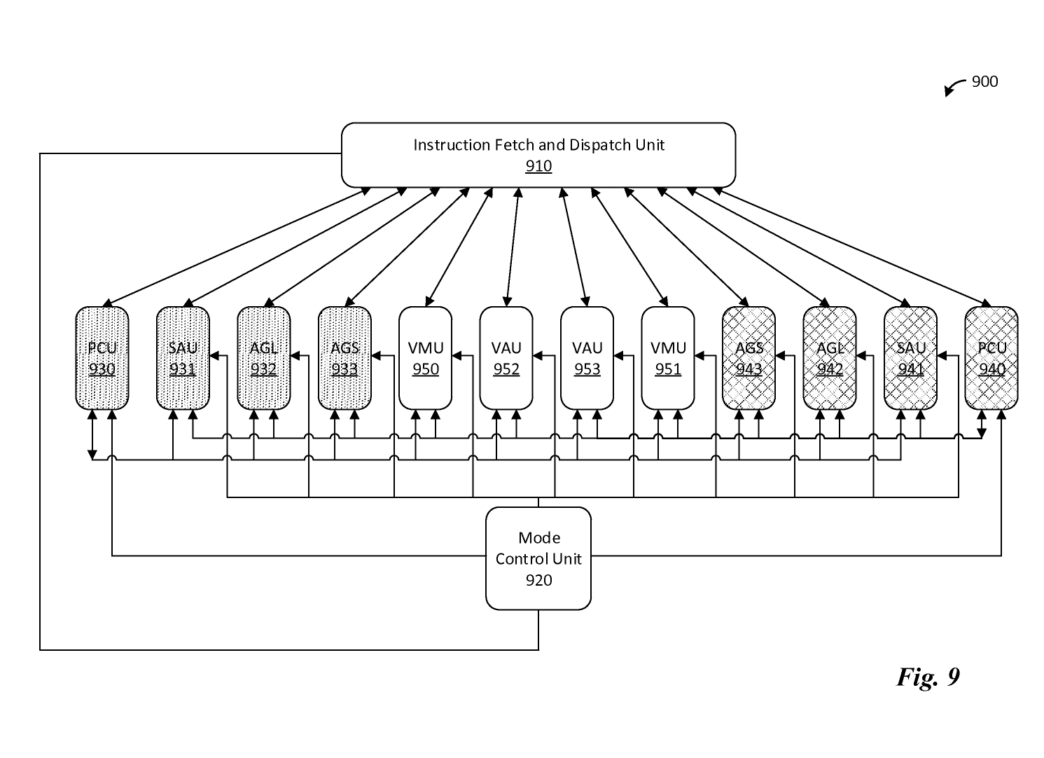

FIG. 9 illustrates an embodiment shared function unit thread partition 900. The shared function unit thread partition 900 includes an instruction fetch and dispatch unit 910, a mode control unit 920, PCUs 930, 940, SAUs 931, 941, AGLs 932, 942, AGSs 933, 943, VMUs 950, 951, and VAUs 952, 953. The shared function unit thread partition 900 may be indicative of partitioned function units in a multithreaded VLIW DSP with shared function units.

As shown in FIG. 9, the PCU 930, SAU 931, AGL 932, and AGS 933 have been organized into a first thread (indicated by the dotted hash pattern). Likewise, the PCU 940, SAU 941, AGL 942, and AGS 943 have been organized into a second thread (indicated by the diagonal hash pattern). The VMUs 950, 951, and the VAUs 952, 953 have not been organized into any particular thread, but may instead be shared by the first and second thread. The first and second threads may thus have varying degrees of parallelism, depending on which thread is using the shared function units. The organization of the function units in the shared function unit thread partition 900 may be performed by the mode control unit 920, as discussed above with respect to FIG. 7.

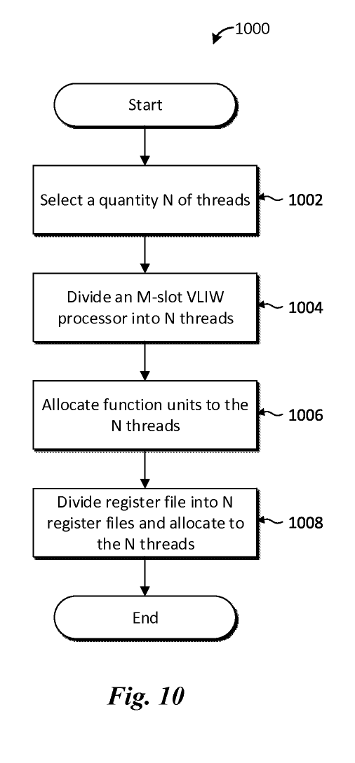

FIG. 10 illustrates an embodiment method 1000 for configuring a multithreaded VLIW DSP. The method 1000 may be indicative of operations occurring, for example, in the mode control unit 720, 820, 920, discussed above with respect to FIGS. 7-9. The method 1000 begins by selecting a quantity N of threads, in step 1002. The method 1000 continues by dividing an M-slot VLIW processor into N threads, in step 1004. The method 1000 continues by allocating function units to the N threads, in step 1006. The method 1000 concludes by dividing a register file into N register files and allocating the N register files to the N threads, in step 1008.

Although the description has been described in detail, it should be understood that various changes, substitutions and alterations can be made without departing from the spirit and scope of this disclosure as defined by the appended claims. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding embodiments described herein. Accordingly, the appended claims are intended to include within their scope such processes, machines, manufacture, compositions of matter, means, methods, or steps.

What is claimed:

1. A processor comprising:
an instruction fetch and dispatch unit;
a plurality of program control units coupled to the instruction fetch and dispatch unit;
a plurality of function units coupled to the plurality of program control units; and
a mode control unit coupled to the plurality of function units and the plurality of program control units, the mode control unit configured to dynamically organize the plurality of function units and the plurality of program control units into one or more threads, each thread comprising a program control of the plurality of program control units and a subset of the plurality of function units.

2. The processor of claim 1, wherein the plurality of function units are equally divided between the threads.

3. The processor of claim 1, wherein the plurality of function units are unequally divided between the threads.

4. The processor of claim 1, wherein each of the one or more threads shares a subset of the function units.

5. The processor of claim 1, further comprising a register file, the mode control unit configured to divide the register file among the threads.

6. The processor of claim 5, wherein the mode control unit is configured to equally divide the register file among the threads.

7. The processor of claim 5, wherein the mode control unit is configured to unequally divide the register file among the threads.

8. The processor of claim 1, wherein each of the threads comprises a very long instruction word (VLIW) thread.

9. The processor of claim 1, wherein each of the threads comprises single instruction, multiple data (SIMD) function units.

10. The processor of claim 1, wherein each program control unit comprises an interrupt controller.

11. A method of organizing a processor comprising:
selecting, by a mode control unit, a quantity of threads into which to divide a processor;
dividing, by the mode control unit, function units into function unit groups, the quantity of function unit groups being equal to the quantity of threads; and
allocating, by the mode control unit, a register file into a plurality of thread register files, each of the thread register files being allocated to one of the function unit groups.

12. The method of claim 11, wherein dividing the function units comprises dividing a subset of the function units into function unit groups.

13. The method of claim 11, wherein one of the function units in each of the function unit groups is a program control unit.

14. The method of claim 11, wherein the function units are organized into one wide thread.

15. The method of claim 11, wherein the function units are organized into a plurality of narrow threads.

16. The method of claim 11, wherein dividing the function units into function unit groups comprises dividing the function units dynamically at run time.

17. The method of claim 16, wherein dividing the function units dynamically at run time comprises scheduling, by an operating system, the function units for the function unit groups.

18. A device comprising:
a processor comprising function units and a register file; and
a computer-readable storage medium storing a program to be executed by the processor, the program including instructions for:
selecting a quantity of threads into which to divide the processor;
dividing the function units into function unit groups, the quantity of function unit groups being equal to the quantity of threads; and
allocating the register file into a plurality of thread register files, each of the thread register files being allocated to one of the function unit groups.

19. The device of claim 18, wherein the instruction for dividing the function units into function unit groups comprises instructions for sharing a subset of the function units between the function unit groups.

20. The device of claim 18, wherein one of the function units in each of the function unit groups is a program control unit.
